(19) United States
(12) Patent Application Publication
(10) Pub. No.: US 2018/0297221 A1
(43) Pub. Date: Oct. 18, 2018

(54) SHAVING RAZOR SYSTEM AND METHOD OF MANUFACTURE

(71) Applicant: The Gillette Company LLC, Boston, MA (US)

(72) Inventor: Matthew James Hodgson, Ramsbury (GB)

(21) Appl. No.: 15/951,339

(22) Filed: Apr. 12, 2018

Related U.S. Application Data
(60) Provisional application No. 62/486,643, filed on Apr. 18, 2017.

(51) Int. Cl. B26B 21/40; B26B 21/44; B26B 21/52

(52) U.S. Cl. CPC B26B 21/4031; B26B 21/521; B26B 21/522; B26B 21/446

(57) ABSTRACT

A shaving razor system with a handle having a first end and a second end. The first end includes a finger pad with a forward rim. A shaving razor cartridge is mounted to the handle in front of the forward rim. The shaving razor cartridge has a guard, a cap and a blade having a blade edge between the guard and the cap. A horizontal distance from the second end of the handle to the forward rim is about 50 mm to about 90 mm and a horizontal distance from the blade edge to the forward rim is about 3 mm to about 20 mm.

### FIELD OF THE INVENTION

The present invention relates to wet shaving safety razors and more particularly to shaving razor systems that have a shaving razor cartridge mounted to an ergonomically formed handle for shaving another person's face.

### BACKGROUND OF THE INVENTION

In general, a cartridge or blade unit of a safety razor has at least one blade with a cutting edge which is moved across the surface of the skin being shaved by means of a handle to which the cartridge is attached. Some shaving razors are provided with a spring biased cartridge that pivots relative to the handle to follow the contours of the skin during shaving. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled.

Razor blade assemblies have been disclosed wherein cutting-edge portions of the blade members are held between skin engaging surfaces which are generally referred to as the guard and cap of the razor blade assembly. The guard contacts the skin in front of the blade member(s) and the cap contacts the skin behind the blade member(s) during a shaving stroke. The cap and guard may aid in establishing the so-called “shaving geometry”, i.e., the parameters which determine the blade orientation and position relative to the skin during shaving, which in turn have a strong influence on the shaving performance and efficacy of the razor. The cap may comprise a water leachable shaving aid to reduce drag and improve comfort. The guard may be generally rigid, for example formed integrally with a frame or platform structure which provides a support for the blades. Guards may also comprise softer elastomeric materials to improve skin stretching.

Personal care givers often care for individuals who are unable to shave themselves because of decreased mental and/or physical capacity often brought about by chronic age, injury, or various degenerative diseases. The task of shaving another person requires extreme care, patience, coordination and spatial awareness to avoid cutting the person being shaved. Unlike shaving yourself, there is no tactile feedback between the person being shaved and the person performing the task of shaving. Furthermore, it may be extremely difficult for a care giver to safely shave a person having tremors. In the United States, barbers are licensed and often have years of experience shaving other people. However, close family members and professional care givers are typically much less familiar with shaving techniques for shaving another person. Furthermore, barbers typically use a straight edge razor, which would be very dangerous for a personal care giver or family member to attempt using on another person without proper training. Wet safety razor shaving systems have been enhanced for over one hundred years for self-application. However, these designs are suboptimal for shaving another person because they do not account for the deficiencies mentioned above.

Thus, there is a need for a shaving razor cartridge mounted to an ergonomic handle to allow for proper control, grip and manipulation for shaving another person's face.

### SUMMARY OF THE INVENTION

In one aspect, the invention features, in general a shaving razor system with a handle having a first end and a second end. The first end includes a finger pad with a forward rim. A shaving razor cartridge is mounted to the handle in front of the forward rim. The shaving razor cartridge has a guard, a cap and a blade having a blade edge between the guard and the cap. A horizontal distance from the second end of the handle to the forward rim is about 50 mm to about 90 mm and a horizontal distance from the blade edge to the forward rim is about 3 mm to about 20 mm.

### BRIEF DESCRIPTION OF THE DRAWINGS

Other features and advantages of the present invention, as well as the invention itself, can be more fully understood from the following description of the various embodiments, when read together with the accompanying drawings, in which:

FIG. 1 is a perspective view of a shaving razor system according to one possible embodiment of the present invention.

FIGS. 2A and 2B are side views of a person's face being shaved by another person with a conventional shaving razor system.

FIGS. 3A, 3B and 3C are side views of the shaving razor system of FIG. 1 having different embodiments of gripping members.

FIG. 4 is a side view of a person's face being shaved by another person with the shaving razor system of FIG. 1.

### DETAILED DESCRIPTION OF THE INVENTION

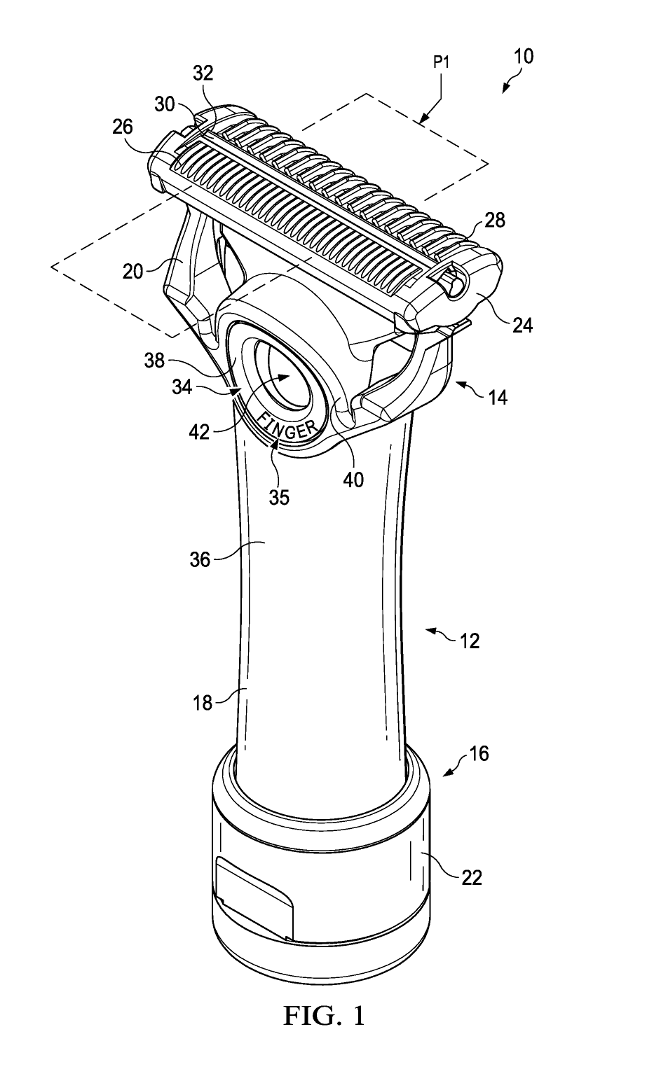

Referring to FIG. 1, a perspective view is shown of a shaving razor system 10. The shaving razor system 10 may include a handle 12 having a first end 14 and a second end 16. In certain embodiments, the handle 12 may include a tottle 18 containing a liquid, such as a pre-or post-shaving aid composition. The tottle 18 may comprise a flexible material, such as polypropylene or polyethylene (e.g., to allow the tottle 18 to be squeezed by a consumer to release fluid contained in the tottle). A tottle is an industry word for a type of bottle (often used for ketchup, shampoo, etc.) that sits on a cap at the end. For example, a “bottle” sits on its “bottom” and dispenses a liquid from the opposite end (top) which has a cap, a “tottle” sits on its “top,” which is the end that dispenses a liquid and has the cap. The handle 12 may also include a coupler 20 mounted to the first end 14 of the handle 12 and an end cap 22 (e.g., removable cover or flip top) at the second end 16 of the handle 12 to allow fluid to exit the handle in an open position and prevent fluid from exiting the handle when in a closed position. A shaving razor cartridge 24 may be mounted to the coupler 20. The shaving razor cartridge 24 may include a cap 26, a guard 28 and at least one blade 30 having a cutting edge 32 positioned between the cap 26 and the guard 28. The cap 26 and the guard 28 may establish a shaving plane P1 (i.e., plane tangent to the cap 26 and the guard 28).

The coupler 20 may include a finger pad 34 on a top surface 36 of the handle 12 (e.g., the tottle 18) for receiving and properly positioning a user's finger or thumb. The finger pad 34 may be circular and have a large radius to receive the thumb of the user to better maintain a user's finger on the finger pad 34. For example, the finger pad 34 may have a radius of about 5 mm to about 15 mm. The finger pad 34 may also have a concave top surface 38 and a forward rim 40. The shaving razor cartridge 24 may be positioned in front of the forward rim 40 of the finger pad 34 (e.g., to facilitate aiming the shaving razor cartridge 24 in the direction of another person's face during shaving). The concave surface 38 may arc in an upward direction and have a radius of about 7 mm to about 25 mm. In certain embodiments, the finger pad 22 may define a through opening 42 extending completely through the finger pad 34 to the top surface 36 of the handle 12 (e.g., tottle 18) thus allowing the user's finger or thumb to rest deeper within the finger pad 34. The top surface 36 of the tottle 18 at a bottom of the through opening 42 may also provide a cushion for improved comfort. In certain embodiments, the finger pad 34 may include an indicia 35 for indicating to the user to position their finger on the finger pad 34 on the top surface 36, not an opposing bottom surface. Accordingly, it may be advantageous for the coupler 20 to be asymmetrical about the tottle 18. The indicia may include words, images, colors or symbols to differentiate the finger pad 34 from the rest of the coupler 20.

When shaving another person's face, the shaving razor system 10 may provide for improved control of a shaving stroke to prevent cutting the person being shaved. When shaving yourself a razor handle is typically held at an angle between 30 degrees and parallel (i.e., 180 degrees) to a plane of the surface of the skin being shaved, either in the form of downward strokes or upstrokes. For a person shaving themselves, this arrangement is generally comfortable and intuitive and also provides good visibility to the area being shaved when looking into a mirror. The hand is kept a good distance from the shave surface, meaning that the reflected view of the area being shaved is not obscured by the shaver's own hand. This scenario has informed the way razors have been designed and optimized for over one hundred years. However, the positional relationship between a shaving razor handle and a person being shaved (subject) is very different compared to self-shaving.

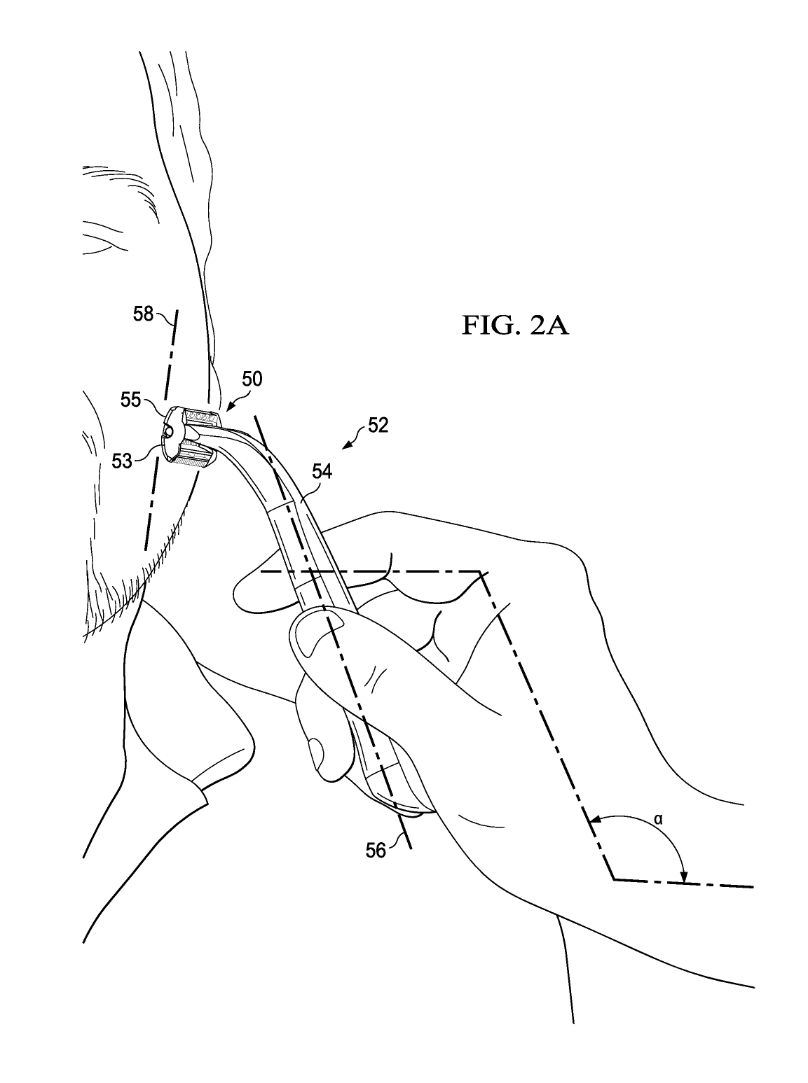

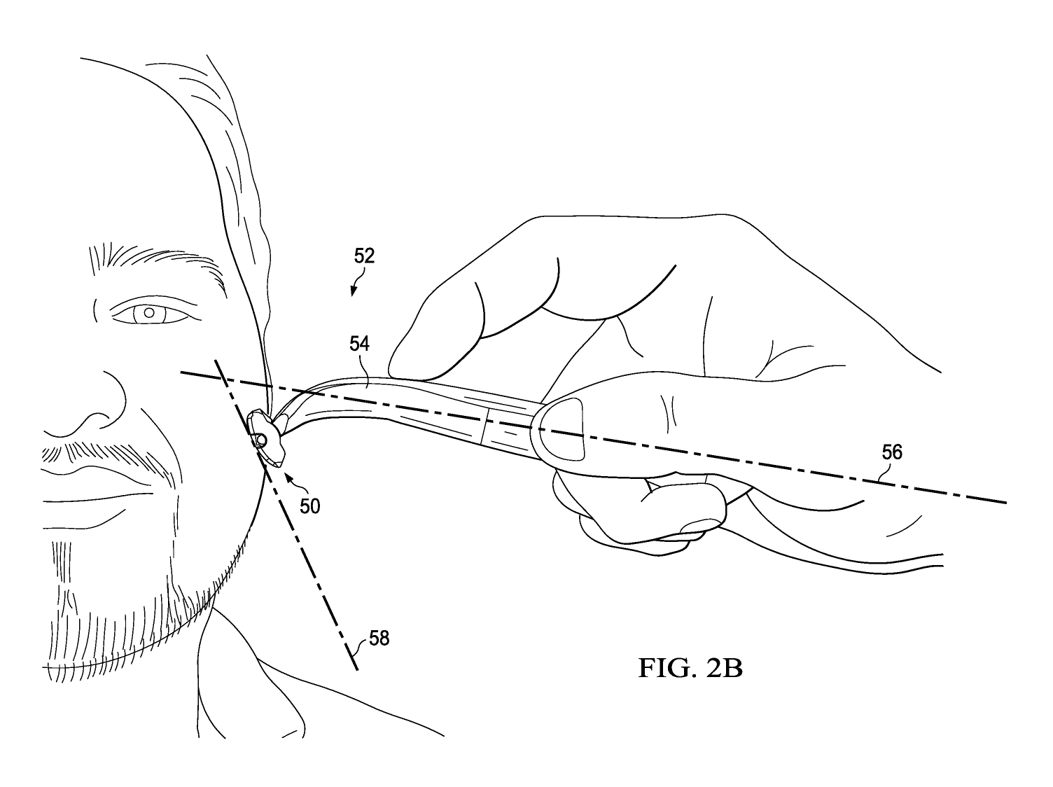

Referring to FIGS. 2A and 2B, side views of a person's face being shaved by another person are illustrated. A shaving razor cartridge 50 may be mounted to an end of a shaving razor handle 52 that has an elongated gripping portion 54 with a longitudinal axis 56. The shaving razor cartridge 50 may define a shaving plane 58 (i.e., plane tangent to a guard 53 and a cap 55 of the shaving razor cartridge 50). The typical self-shave model becomes no longer valid when shaving another person because it creates several problems. When shaving another person, the person being shaved (i.e., the subject), is commonly in a sitting or lying down position while the person performing the shaving function (i.e., the care giver) is standing. The relative position of the care giver and subject creates a relatively low face and neck position, making positioning the shaving razor cartridge 50 utilizing a conventional grip and stroke (as shown in FIG. 2A) far more difficult and uncomfortable, as illustrated by the exaggerated wrist angle “a”. The hand may be generally parallel to the handle axis 56 (and the shaving plane 58), thus putting the wrist in a transverse position relative to the hand.

Other handle grips may be used, as illustrated in FIG. 2B. For example, the handle 52 may approach the subject's face at a higher razor handle angle that may be generally perpendicular to the skin being shaved. The wrist angle may create a more neutral position (e.g., straight or 180 degrees), which may result in a more comfortable position for the care giver. However, this position also leads to a poor blade to skin angle resulting in poor shaving performance (e.g., efficiency and safety). For example, the shave plane 58 does not conform very well to the surface of the skin being shaved (e.g., the shave plane 58 is lifted off the surface being shaved). Furthermore, the cartridge 50 may pivot to a full pivot position prematurely as the cartridge 50 is placed onto the skin. Accordingly, the skin conforming and safety benefits of a pivoting cartridge are largely mitigated. Most shaving razors sold on the market today have a handle with a distal end that curves downward to attach to a cartridge.

Current razor handle designs are also not optimal because the subject's relatively low position results in the care giver having to bend over the subject to improve visibility and access to the area to be shaved. In this scenario, there are many areas of the face and neck that are significantly more difficult to shave, such as, the underside of the jaw and the area where the neck meets the jaw. The raising or turning of the subject's head is often not possible when shaving someone with diminished physical or mental capacity. Barbers typically solve this problem by seating their subjects in a chair that is able to recline, swivel and change height to achieve the optimum physical setup. This is often not practicable when shaving someone at home or in a care giver's facility. In addition, for many men in care with reduced mental capacity, sitting still during the shaving process is not always possible. Unpredictable movements present a serious safety risk and makes shaving the subject significantly more challenging.

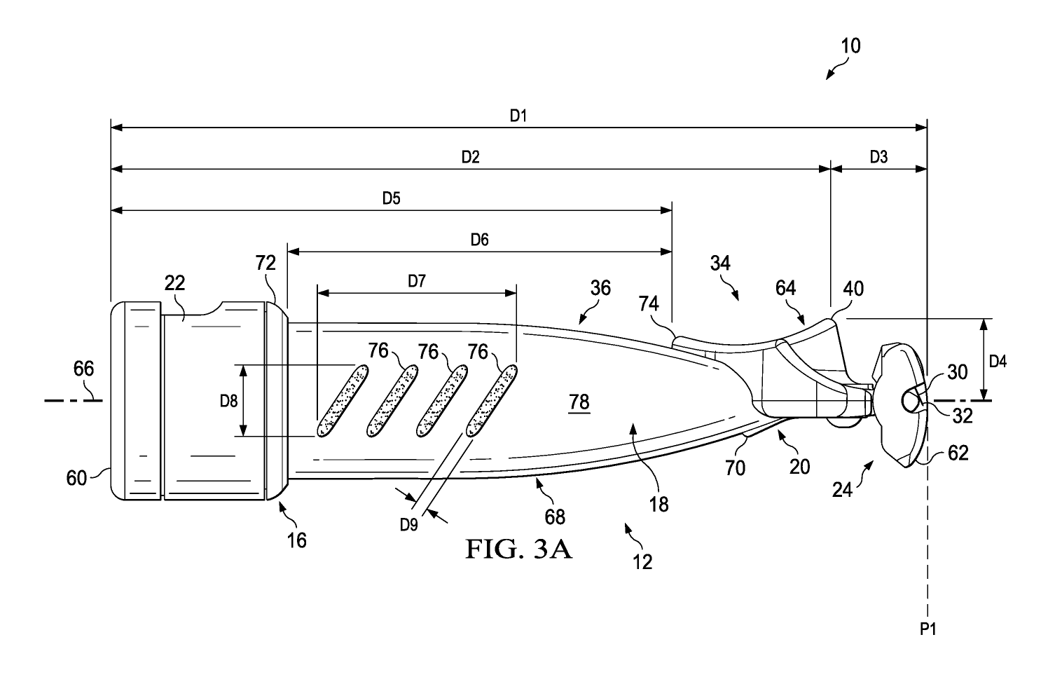

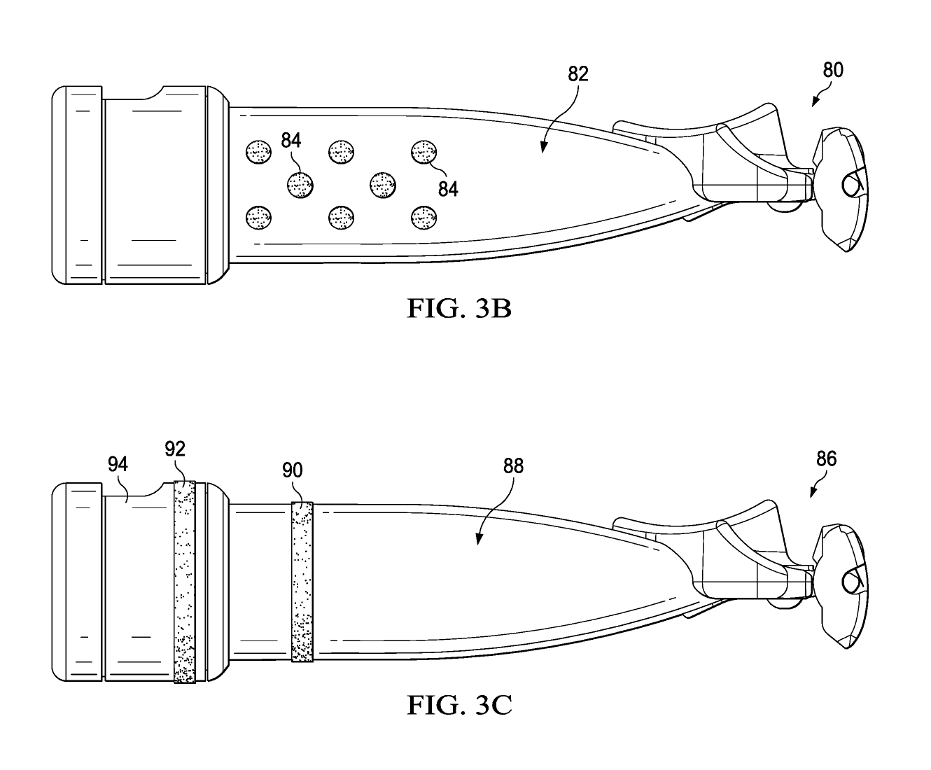

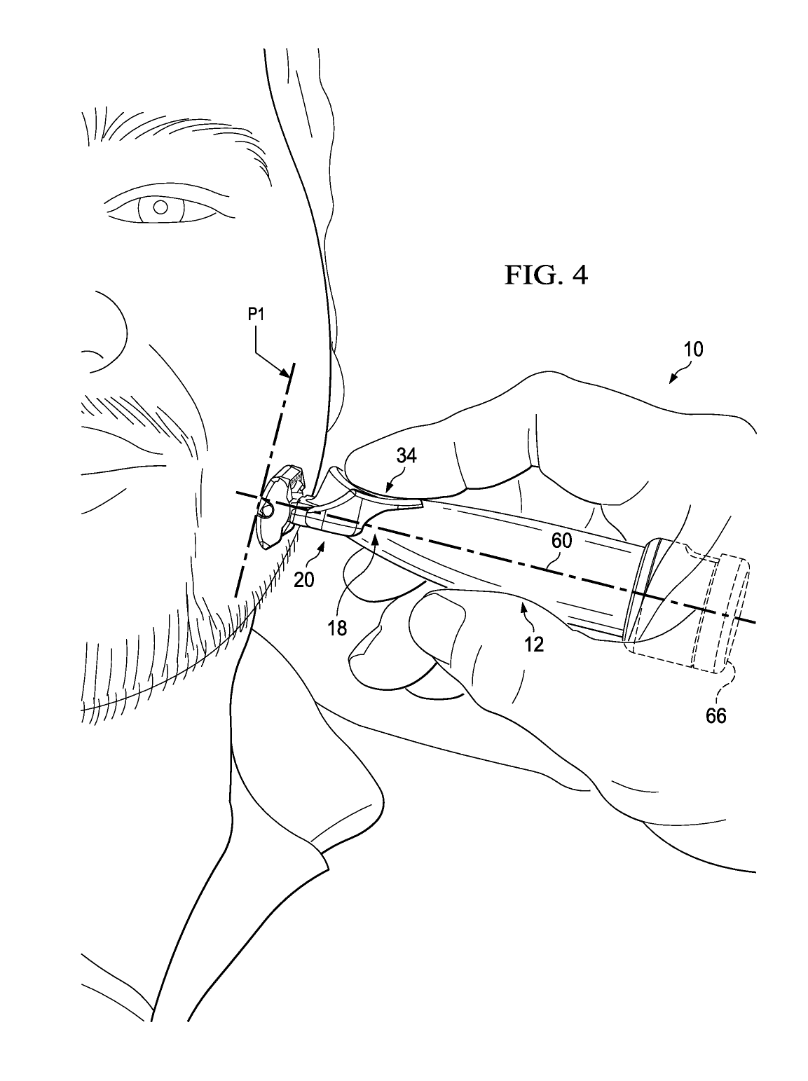

Referring to FIG. 3A a side view of the shaving razor system 10 of FIG. 1 is shown. In certain embodiments, the second end 16 may have a bottom surface 60 (e.g., of the end cap end 22) that is flat to provide an area for the palm of a user's hand to rest against comfortably, as shown in FIG. 4. As will be described in greater detail below, the bottom surface 60 may have a generally circular cross section to allow the bottom surface 60 to sit comfortably against a user's palm. The shaving razor system 10 may have a first distance “D1” measured as a horizontal distance from the bottom surface 60 to a front-end face 62 of the shaving razor cartridge 24 of about 70 mm to about 100 mm. The distance “D1” may be long enough for a user to hold the shaving razor system 10 comfortably while also positioning the bottom surface 60 against the palm of the user to prevent unintended opening and dispensing of the liquid. For example, if the handle 12 is too long, the user may not bottom out the bottom surface 60 against their palm and may also apply more pressure on the sides (or top and bottom surface) of the handle 12. The pressure applied to the handle 12 (i.e., tottle) may force the end cap 22 to open and unintentionally expel the liquid contained in the handle 12 (i.e., tottle).

The shaving razor system 10 may have a second distance “D2” measured as a horizontal distance from bottom surface 60 of the handle 12 to the forward edge 40 of the finger pad 34. The distance “D2” may also aid the user in positioning their hand in the proper position for shaving another person. For example, if “D2” was too large, the handle 12 would not fit comfortably between the user's finger (resting in the finger pad 34) and the palm of their hand (resting against the bottom surface 60). Accordingly, the forward rim 40 may act as a datum for the user's finger and the second end 16 (i.e., bottom surface 60) may act as a datum for the user's hand (e.g., palm) resulting in an intuitive holding position. In certain embodiments, the distance “D2” may be about 50 mm to about 90 mm, and more preferably about 60 mm to about 80 mm.

The shaving razor system 10 may have a third distance “D3” measured as a horizontal distance from the forward edge 40 of the finger pad 34 to the cutting edge 32 of the blade 30. In certain embodiments, the distance “D3” may be about 3 mm to about 20 mm, and more preferably about 5 mm to about 15 mm. The distance “D3” may allow the positioning of the user's finger as close as possible to the surface to be shaved, which may be important when shaving another person for improved control of the shaving razor system 10. The positioning of the forward edge 40 of the finger pad 34 relative to the cutting edge 32 may provide the user an improved line of vision of the surface being shaved. For example, a front face 64 of the finger pad 34, terminating in the forward rim 40, may be directed toward the cutting edge 32. Accordingly, the user has less obstructions to their line of sight and the user is able to apply proper pressure against the surface of the front face, perpendicular to the shaving stroke so adequate pressure is applied to the skin. The handle 12 may have a center longitudinal axis 66 that passes through the shaving razor cartridge 24 and/or the blade 30. The center longitudinal axis 66 may be transverse to the shave plane P1 when the shaving razor cartridge 24 is in a resting position. In certain embodiments, the forward rim 40 may be offset at a vertical distance “D4” of about 0 mm to about 25 mm from the center longitudinal axis 66 of the handle 12. The forward rim 40 may also be positioned a total distance of about 7 mm to about 32 mm from the cutting edge 32 of the blade 30 to allow a user's finger to rest as close as possible to the cutting edge without interfering with pivoting of the shaving razor cartridge. In certain embodiments, the coupler 20 may be clamped to the tottle 18 with the finger pad 34 positioned on the top surface 36 and a rigid tab 70 positioned on a bottom surface 68 directly beneath the finger pad 34 to improve rigidity of the handle 12. The rigid tab 70 may have a lower profile than the finger pad 34 which may provide improved access to areas of another person's face, such as the upper neck below the chin and jaw line. The rigid tab 70 may have an indicia indicating it is the wrong side up (i.e., finger should be placed on the finger pad 34 on the opposite side).

In certain embodiments, the end cap 22 may have a cross sectional area that is greater than a maximum cross-sectional area of the tottle 18, to provide a shoulder 72. The shoulder 72 may allow a user to comfortably position one or more fingers to hold or grip the handle 12. The finger pad 34 may have a rearward edge 74 that is positioned closer to the center longitudinal axis 66 than the forward rim 64 of the finger pad 34. The rearward edge 74 of the finger pad may be positioned at a horizontal distance “d5” of about 20 mm to about 80 mm from the bottom surface 60. In certain embodiments, the internal volume of the tottle 18 may be sufficient for only a single shave. For example, the volume of the tottle 18 may be about 5 ml to about 50 ml. The volume of the tottle 18 may also allow for the consumer to properly hold the shaving razor system 10. Tottles are flexible structures, especially when they are empty. Accordingly, a tottle type handle can become floppy in a user's hand, which may be dangerous when shaving another person because of the lack of control. The size of the tottle 18, and the coupler 20 may allow the shaving razor system to be supported properly in a user's hand between the coupler 20 and the end cap 22 to limit flexing of the tottle 18.

Tottles are intended just to dispense a fluid and typically are not designed to be held in any specific configuration, apply a force on another object, or held for any significant amount of time. Typically, their sole function is to dispense a fluid. Accordingly, utilizing a tottle as a handle may not provide a sufficient grip for the consumer to position their hand, thumb and fingers. The tottle 18 may have at least one gripping member 76 on a side surface 78 (i.e., transverse to the top surface 36) of the tottle 18 with a thickness greater than 50 um. For example, the gripping member 76 may have a thickness of about 200 um to about 2.0 mm. The gripping member 76 may be positioned between the end cap 22 and the coupler 20. Although only one side of the shaving razor system 10 is shown, it is understood that the opposing side may have the same features. The gripping member 76 may have a textured surface with an Ra value of at least 300 to provide for an improved grip. The gripping member 76 may have a textured surface with an Ra value greater than an Ra value of a surface (e.g., side surface 78) of the tottle 18 adjacent the gripping member 76. The gripping member may comprise a different material than the end cap 22 and/or the tottle 18 to provide an improved grip of the tottle 18. In certain embodiments, the tottle 18 may have a plurality of gripping members 76. For example, FIG. 3A illustrates four gripping members 76 that are spaced apart on the side surface 78 of the tottle 18. The gripping member(s) 76 may have a span “D7” of about 50% to about 100% of a distance “D6” between the end cap 22 and the coupler 34. The gripping member 76 may comprise a strip having a width of 0.10 mm to 10 mm and a length of 0.10 mm to 10 mm. The positioning and placement of the gripping members 76 may help guide a user to the proper holding position, thus creating a more intuitive holding position.

FIGS. 3B and 3C illustrate alternative embodiments of the gripping member 76 of FIG. 3A. For example, FIG. 3B shows a shaving razor system 80 having a tottle 82 with a plurality of gripping members 84 that are circular bumps that are applied to the tottle 82. FIG. 3C illustrates a shaving razor system 86 having a tottle 88 with an annular gripping member 90 that extends around a circumference of the tottle 88. An annular gripping member 92 may be applied to the end cap 94. The shaving razor systems 80 and 86 may be substantially the same as the shaving razor system 10 shown in FIG. 1. FIGS. 3B and 3C illustrate various other executions for applying a gripping member. It is understood there may be various means for increasing a consumer's ability to grip the shaving razor systems 10, 80 and 86. For example, the means for increasing grip may include applying a label having a textured outer surface, applying an adhesive-backed elastomer, die cut features or applying a gripping member utilizing printing and other deposition means.

Referring to FIG. 4, a side view of a user shaving another person's face with the shaving razor system 10 of FIG. 1 is illustrated. As shown in FIG. 4, the size of the tottle 18, location of the finger pad 34 on the coupler 20 relative to the bottom surface 60 of the handle 12 facilitates an intuitive hand and finger orientation when a user is shaving another person's face. For example, the thumb and middle finger are positioned on opposing sides of the tottle 18, the middle finger is positioned on the finger pad 34 and the bottom surface 60 of the handle 12 is firmly pressed against the palm of the hand, thus providing a secured grip of the shaving razor system 10. The bottom surface 60 may have a sufficient cross sectional area so the handle 12 does not dig into the user's hand. For example, the bottom surface may have a cross sectional area of about 140 mm² to about 1250 mm² and more preferably about 250 mm² to about 500 mm². The hand position facilitated by the shaving razor system 10 allows the user to approach a surface to be shaved (e.g., the surface to be shaved rests against the plane P1) to be substantially perpendicular to the center longitudinal axis 66 of the handle 12. It is believed, without being held to theory, the intersection of the shave plane and center longitudinal axis of a shaving razor should be closer to perpendicular for shaving another person (i.e., third party shaving).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor system comprising:
a handle having a first end and a second end, the first end including a finger pad with a forward rim;
a shaving razor cartridge mounted to the handle in front of the forward rim, the shaving razor cartridge having a guard, a cap and a blade having a blade edge between the guard and the end cap, wherein a horizontal distance from the second end of the handle to the forward rim is about 50 mm to about 90 mm, and a horizontal distance from the blade edge to the forward rim is about 3 mm to about 20 mm.

2. The shaving razor system of claim 1 wherein the horizontal distance from the second end of the handle to the forward rim is about 60 mm to about 80 mm, and the horizontal distance from the blade edge to the forward rim is about 5 mm to about 15 mm.

3. The shaving razor system of claim 1 wherein the finger pad defines an opening.

4. The shaving razor system of claim 1 wherein the finger pad has a concave surface.

5. The shaving razor system of claim 1 wherein the second end is flat.

6. The shaving razor system of claim 5 wherein the second end comprises a bottom surface having a generally circular cross section.

7. The shaving razor system of claim 1 wherein the handle has a center horizontal axis that passes through the shaving razor cartridge.

8. The shaving razor system of claim 1 wherein the forward rim is positioned at a vertical distance of about 0 mm to about 25 mm above a center axis of the handle.

9. The shaving razor system of claim 1 wherein the forward edge is positioned a total distance of about 7 mm to about 32 mm from the blade edge.

10. The shaving razor system of claim 1 wherein the handle comprises a tottle containing a fluid.

11. The shaving razor system of claim 10 further comprising an end cap.

12. The shaving razor system of claim 10 wherein the finger pad is positioned on a top surface of the tottle and a rigid tab is positioned on a bottom surface of the tottle under the finger pad.

13. The shaving razor cartridge of claim 12 wherein the rigid tab has a plurality of spaced apart ribs contacting the bottom surface of the tottle.

14. The shaving razor system of claim 1 further comprising a pair of arms that extend laterally and forward of the finger pad, wherein the cartridge is mounted to the pair of arms.

15. The shaving razor system of claim 1 wherein the finger pad has a rearward edge that is a horizontal distance of about 60 mm to about 80 mm to the second end.

16. The shaving razor system of claim 15 wherein the finger has a radius of about 5 mm to about 15 mm.

17. The shaving razor system of claim 1 further comprising an indicia on the finger pad.

18. The shaving razor system of claim 1 wherein the bottom surface has a cross sectional area of about 250 mm² to about 500 mm².

19. The shaving razor system of claim 1 wherein the coupler is asymmetrical.

20. The shaving razor system of claim 1 wherein the finger pad has a concave surface with a radius of about 7 mm to about 25 mm.
